(19) United States
(12) Patent Application Publication
(10) Pub. No.: US 2012/0139362 A1
(43) Pub. Date: Jun. 7, 2012

(54) Fail-Safe Switching Module

(75) Inventors: Martin FICHTLSCHERER, Amberg (DE); Philipp Löhdefink, Nurnberg (DE); Mario Maier, Ensdorf (DE)

(73) Assignee: Siemens Aktiengesellschaft, Muenchen (DE)

(21) Appl. No.: 13/312,011

(22) Filed: Dec. 6, 2011

(30) Foreign Application Priority Data
Dec. 6, 2010 (EP) EP10193833

(51) Int. Cl. H01H 47/00

(52) U.S. Cl. 307/113

(57) ABSTRACT

A fail-safe switching module having a first switching device and a second switching device, the first and second switching devices being configured to switch a load by a switching-on device, a first temperature sensor being arranged on the first switching device and a second temperature sensor being arranged on the second switching device. The first switching device is arranged in series with first and second switching-off devices, and the second switching device is arranged in series with third and fourth switching-off devices. The first switching-off device and the third switching-off device are configured to react to the first temperature sensor. The second and fourth switching-off devices are configured to react to the second temperature sensor to switch off the first and second switching devices in the event of an overtemperature of the first switching device or the second switching device.

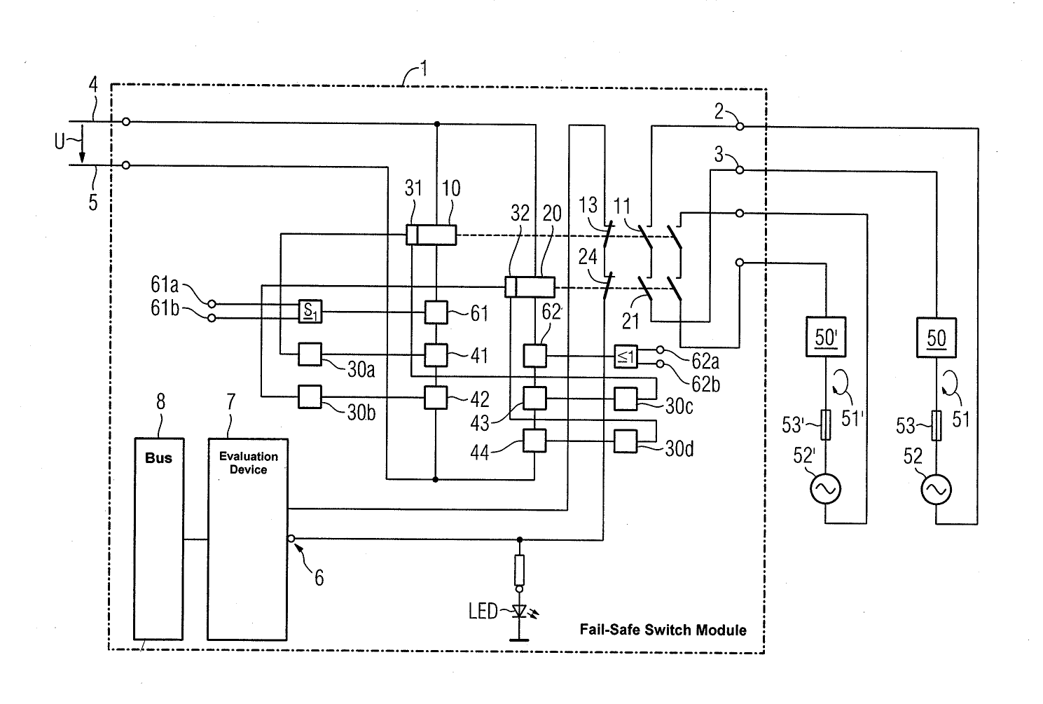

### BACKGROUND OF THE INVENTION

1. Field of the Invention

The invention relates to switching modules and, more particularly, to a fail-safe switching module having a first switching device and a second switching device, where the switching devices are configured to switch a load using a switching-on device.

2. Description of the Related Art

In general fail-safe switching modules are used, for example, in process automation for switching motors or higher-order contactors.

The manual “SIMATIC, Dezentrale Peripherie F-Technik, Dezentrales Peripheriesystem ET 200S” issue 08/2008, order number A5E00103684-07, discloses one type of switching module in chapter 7.8, pages 187-197.

As part of increasing miniaturization, the conventional switching module is to be reduced in terms of its size, form factor and installation width. The conventional housing of such a switching module must therefore be significantly reduced in terms of its external measurements. However, the reduction in the proportions of the housing causes an increased generation of heat within the switching module due to the switching device.

### SUMMARY OF THE INVENTION

It is therefore an object of the present invention to provide a switching module that reacts in a fail-safe manner as a result of excessive heating.

This and other objects and advantages are achieved in accordance with the invention by providing a fail-safe switching module having a first switching device and a second switching device, where the switching devices are configured to switch a load by a switching-on device. In accordance with the invention, a first temperature sensor is arranged on the first switching device and a second temperature sensor is arranged on the second switching device, where the first switching device is arranged in series with a first switching-off device and a second switching-off device. The second switching device is arranged in series with a third switching-off device and a fourth switching-off device, where the first switching-off device and the third switching-off device are configured to react to the first temperature sensor, and the second switching-off device and the fourth switching-off device are configured to react to the second temperature sensor to switch off the switching device in the event of an overtemperature of the first switching device or of the second switching device. A fault involving inadmissible heating is accordingly advantageously taken into account.

If one of the switching devices should exhibit excessive power loss, this excessive power is detected by one of the temperature sensors. The switching-off devices are arranged in a pickup current circuit of the corresponding switching device in this case, and can interrupt this pickup current circuit in the event of an overtemperature. This provides a safety cutoff.

In a further embodiment of the switching module, the module is advantageously provided with a device for reducing the power loss of the switching devices which, after a closed position of the switching-on device has been attained, is configured to generate a holding current for the switching device to hold the closed position with reduced power. If relays, for example, are used as the switching devices, then these relays have a very high power loss due to permanent activation. A holding power is smaller than the pickup power in a relay. Following definite picking up of such a relay, i.e., a reaction of the relay with a pickup current, the reducing device ensures that the relay is, for example, now only clocked, for example, with a pulse-width modulation.

In an advantageous embodiment, the device for reducing the power loss is configured as a first reducing device, which is arranged in series with the first switching device, and as a second reducing device, which is arranged in series with the second switching device. The reducing devices, similarly to the switching-off device, are arranged in the circuit of the switching device or of the relay. As a result, the reducing devices can be operated such that, for a holding current, such a high current as is required for reaction or picking up of the switching devices or relays no longer flows through the switching device.

A power reduction of this kind is achieved in particular by a pulse-width modulation (PWM). Using the example of a relay, a relay (e.g., a monostable relay) of this kind can be operated in a “setback mode”. These monostable electromechanical relays have the greatest energy requirement at the switching-on instant if, for example, an armature has the greatest spacing (i.e., an air gap) from a coil core. Once the armature has picked up, the air gap is overcome and following activation a holding voltage is then only about 30 to 50% of an exciting voltage of the relay.

A combination of the reducing devices and the switching-off devices within the switching module has proven to be particularly advantageous because the switching devices can be operated with a reduced power due to the reducing devices. Here, the housing size may also be significantly reduced, which leads to a compact construction whereby air cooling of the components, i.e., the switching devices, is no longer required. However, with fail-safe switching modules everything has to be designed so as to be fail-safe. Accordingly, it must also be ensured that the reducing devices work properly. As a result, a situation in which the switching devices or the relays do not work in continuous operation with reduced power but with full power loss must be avoided. If this situation is not avoided, the switching module will reach an over-temperature range such that the switching devices no longer function properly. The combination of temperature monitoring and reduction in power loss further increases the fail-safe nature of such a fail-safe switching module.

If pulse-width modulation (PWM) is used for power reduction and this PWM modulation were to have a fault and, for example, be permanently “1”, the admissible temperature range will be exceeded. It is thus no longer possible to ensure that the associated switching device or relay can still switch off safely. The switching-off device therefore immediately switches off in collaboration with the temperature monitoring of the temperature sensor in the event of an inadmissibly high temperature.

The switching-on devices preferably comprise switching contacts of the switching devices. An additional heat source may be produced thereby which is to be avoided.

If a switching device, such as a relay, closes a switching contact, then an arc may be produced on the switching contact. An arc may also be produced when a switching contact is opened. Thus, a switch-on arc and a switch-off arc can therefore be contemplated. During the switching processes, not only is heat produced by this arc but the contact surfaces can also wear, and in the worst case the contact may become welded after frequent opening and closing of the switching contact. In this connection, welding of the contact is taken to mean that the contact is permanently closed. In particular, with fail-safe modules, such as a relay module for switching loads, the situation where a switching contact may no longer be switched off or may no longer be opened must be avoided at all costs. In fail-safe relay modules, two switching contacts of two relays in series are therefore preferably switched. As a result, in the event of a switching contact being welded, the load can still be switched off or a short-circuit can still be interrupted by the switching contact of the respective other relay. To prevent welding of additional contacts connected in series, in the event of short-circuiting of the load, a fusible cutout is prescribed to protect the contacts in a load circuit.

Fusing can be avoided with the fail-safe switching module if the first switching device in a series connection is arranged with a first enabling device between the activating wires, where the first enabling device is configured to delay activation of the first switching device. In the process, the first switching device is, for example, a relay. In accordance with the presently contemplated embodiment, an additional enabling device is arranged in a circuit for activation of the relay which can interrupt a current flow through the relay and can therefore cause a switch-on delay. In certain embodiments, the additional enabling device is configured as an additional mechanical contact, as a power semiconductor or a transistor. A result of the delay in activation of the first switching device is that the first switching device reacts later than the second switching device, although the first switching contact is also closed later than the second switching contact thereby. Only when the second switching contact is completely closed is the first switching contact closed. This chronology of switching ensures that an arc preferably occurs at the first switching contact during a switching-on process or a switching-off process. Consequently, due to a load current and the wear on the first switching contact caused thereby, the first switching device would always fail first. Here, the first switching device comprises a load relay. The second switching contact of the second switching device, which corresponds to a second relay, is also called a load-free relay. The second switching contact of the load-free relay is spared thereby.

In an advantageous embodiment, the first enabling device is connected to a first delay circuit. The delay circuit can affect the duration of the delay.

In a further optimized embodiment, the second switching device is arranged in series with a second enabling device between the activating wires, where the second enabling device is configured to extend activation of the second switching device. As already mentioned in the introduction, an arc is produced both during a switching-on process and a switching-off process, and can therefore damage the contacts, such as a relay. As a result, an extension of the activation time of the second switching device is also achieved with a second enabling device. Using the example of a relay for the second switching device a holding current can therefore be maintained for the relay for a certain time by the second enabling device, and the result of this is that the corresponding second switching contact also opens at a later moment in time. The first switching contact has already opened and incurred the arc even before the second switching contact is opened. As a result, the second switching contact is also spared during an opening process.

In a further embodiment, the second enabling device is also advantageously connected to a further delay circuit.

It is also advantageous if an energy store, i.e., a buffer capacitor, is arranged between the activating wires to extend activation of the second switching device.

In another embodiment of the switching module, the first switching device advantageously comprises a third switching contact and the second switching device comprises a fourth switching contact, where the first and the second switching contacts are configured as make contacts and the third and fourth switching contacts as break contacts. A monitoring circuit can be formed with the switching contacts, which are configured as break contacts, whereby a fault in the affected relay can be detected.

For fault detection, it is expedient if the third switching contact and the fourth switching contact are arranged in series with respect to a read-back input of an evaluation device, where the read-back input is configured as an inverting input. Here, the third and fourth switching contacts are configured as break contacts, and during a switching process switch at the same time as the first and second switching contacts. As a result, a defect in a relay, for example, can be detected if the break contact remains permanently open and does not find itself back in its closed position. There would then be a permanent input signal across the inverting input at the read-back input which can be evaluated in conjunction with the instantaneous activation situation, and a possible fault may be determined therefrom.

In a further improved embodiment, the switching module comprises a backplane bus configured for modular construction of a decentralized automation system with a plurality of electronic modules located next to each other. An automation system of this kind with a modular construction can be used, for example, for fail-safe automation systems (F systems) in units with increased safety requirements. These F systems are used for controlling processes with a safe state that can be attained immediately by switching off. The fail-safe modules used here differ substantially from the standard modules in that they are constructed with two channels internally.

In a method for operating the fail-safe switching module, a switching voltage is applied to the first activating wire and the second activating wire to switch the load, and this prepares closing of the load circuit such that the second switching contact is closed by activation of the second switching device with the switching voltage. Upon completion of a closing process of the second switching contact, the first enabling device is operated such that it is likewise activated by the switching voltage and then the first switching contact closes.

In an embodiment, the method is also expanded to a switching-off process. Here, in order to switch off the load, the switching voltage is disconnected from the activating wires, and opening of the load circuit is achieved in that the first enabling device is operated such that it disconnects the first switching device from the activating wire. Upon completion of the opening process of the first switching contact, the second enabling device is operated such that it maintains a current flow through the second switching device due to the energy store.

To obtain a diagnosis possibility the method is expanded in that a third switching contact is opened at the same time as the first switching contact is closed and a fourth switching contact is opened at the same time as the second switching contact is closed, where a read-back signal is generated for a read-back input by a series connection of the third and fourth switching contacts.

As a result of the switching processes controlled in the manner described, the method can advantageously be used when switching-on and switching-off the load circuit, comprising the load, a voltage source and a fusible cutout, such that an automatic circuit-breaker is used instead of a fusible cut-out. Due to the length of the temporal offset when switching the switching contacts, such as the two relays, a fusible cut-out prescribed in accordance with safety regulations can advantageously be omitted because it is now no longer possible for the two switching contacts to weld and therefore be permanently closed. Even in the case of a connection to an existing short-circuit, the second switching contact would have initially closed and would therefore not have caused an arc. The first switching contact which then closes would incur an arc, and with connection to a short-circuit would presumably also fuse. At the instant of fusing of the first switching contact, the automatic circuit-breaker would also have already triggered, however. The second switching contact still occurs in time, however, in accordance with the dictates of the safety regulations for fail-safe switching modules.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described in more detail with the aid of the drawing, in which:

The FIGURE shows a block diagram of a fail-safe switching module in accordance with the invention.

### DETAILED DESCRIPTION OF THE PREFERRED EMBODIMENTS

With reference to the FIGURE, shown therein is a fail-safe switching module 1 for switching a load 50. To close a load circuit 51, a first switching contact 11 and a second switching contact 21 are arranged in series between a first connection terminal 2 and a second connection terminal 3. Activating a first switching device 10 and a second switching device 20 with a switching voltage U causes the switching devices 10, to switch. The first switching contact 11 forms part of the first switching device 10, which is indicated by a broken function line. The second switching contact 21 forms part of the second switching device 20, which is likewise indicated by a broken function line. In addition, the switching devices 10,20 are arranged between a first activating wire 4 and a second activating wire 5.

To enable the switching module 1 to be compactly introduced into a housing such that air cooling of the components used, i.e., the switching devices 10,20, is no longer necessary, the switching module 1 is configured as follows.

A first temperature sensor 31 is arranged on the first switching device 10 and a second temperature sensor 32 is arranged on the second switching device 20, where the first switching device 10 is arranged in series with a first switching-off device 41 and a second switching-off device 42, and the second switching device 20 is arranged in series with a third switching-off device 43 and a fourth switching-off device 44.

The first switching-off device 41 and the third switching-off device 43 are configured such that they can react to the first temperature sensor 31 and thereby cause switching off.

In other words, one switching-off device respectively is arranged in each of the two pickup current circuits for the first switching device 10 or for the second switching device 20, and this reacts to an over-temperature of just one switching device. Consequently, if the first switching device 10 exhibits an over-temperature, then the second switching device 20 is also switched off.

The second switching-off device 42 and the fourth switching-off device 44 are configured to react to the second temperature sensor 32. As a result, the first switching device 10 can also be switched off if the second switching device 20 exhibits an over-temperature. A “crossover” switching-off process thus occurs.

To increase accuracy, a first temperature evaluation circuit 30a is arranged between the first temperature sensor 31 and the first switching-off device 41. The temperature sensor 31, comprising, for example, a PTC resistor, therefore communicates its change in temperature to the temperature evaluation circuit 30a, the circuit can react thereto and can deliver a switch-off signal to the first switching-off device 41.

As described using the example of the first temperature evaluation circuit 30a, activation of the second switching-off device 42 functions based on the second temperature sensor 32, activation of the third switching-off device 43 based on the first temperature sensor 31, and activation of the fourth switching-off device 44 based on the second temperature sensor 32 with the corresponding temperature evaluation circuits 30b,30c and 30d.

In a combination with the temperature monitoring by way of the first temperature sensor 31 and second temperature sensor 32, a first reducing device 61 is arranged in series with respect to the first switching-off device 41 and second switching-off device 42. A second reducing device 62 is also arranged in series with respect to the third switching-off device 43 and fourth switching-off device 44.

The reducing devices 61,62 are each activated by way of an OR operation with an activation signal 61a or 62a and a pulse-width modulation (PWM) signal 61b or 62b.

If, for example, the first switching device 10 picks up for the first time, a first activation signal 61a is provided by the OR operation to the first reducing device 61. Once the first switching device 10 has definitely picked up, the first activation signal 61a can be withdrawn and the first switching device 10 held in a setback mode or holding mode by the first PWM signal 61b.

The same applies to the second switching device 20. For first-time pick-up of the second switching device 20 a second activation signal 62a is again applied here to the OR operation, and this acts on the second reducing device 62. Once the second switching device 20 has fully picked up, the second switching device 20 can be kept in a holding mode by the second PWM signal 62b. Operation of the first switching device 10 and the second switching device 20 in a holding mode can reduce power loss by about 50%, as compared with permanent activation of the switching device 10,20. The result of this reduction is that no excessive power loss is converted into heat in switching module 1, which could result in a possible over-temperature.

If an over-temperature should occur nonetheless, for example, due to a faulty activation with the first PWM signal 61b or the second PWM signal 62b, this would be detected by the first temperature sensor 31 or second temperature sensor 32, and since these temperature sensors 31,32 act on the corresponding switching-off device 41, . . . , 44, the switching device can be switched off and pass into a safe operating mode.

A first enabling device is arranged between the activating wires 4,5 in series with respect to the first switching device 10 to make the switching module 1 safe with respect to arc formation. The first enabling device is configured to delay activation of the first switching device 10. The first enabling device is connected to a first delay circuit to assist the delay process.

Also arranged in series with respect to the second switching device 20 is a second enabling device between the activating wires 4,5. The second enabling device is configured to extend activation of the second switching device 20. The second enabling device is connected to a second delay circuit. The switching voltage U is applied to the first activating wire 4 and the second activating wire 5 to switch on the load 50. Closing of the load circuit 51 is prepared for in that the second switching contact 21 is closed by activation of the second switching device 20 with switching voltage U, and once a closing process of the second switching contact 21 is complete the first enabling device is operated such that the first switching device 10 is likewise activated by the switching voltage U and then the first switching contact 11 closes. Since only now the load circuit 51 is completely closed, the first switching contact 11 incurs an arc, which is produced, for example, by switching inductive or capacitive loads.

The switching voltage U is disconnected from the activating wires 4,5 to switch off the load 50. Opening of the load circuit 51 is achieved in that the first enabling device is operated such that it disconnects the first switching device 10 from the activating wire 5 and once an opening process of the first switching contact 11 is complete the second enabling device is operated such that it maintains a current flow through the second switching device 20 based on an energy store. Opening of the second switching contact 21 is delayed thereby, where during the opening process of the second switching contact 21 current no longer flows in the load circuit 51 and therefore no arc can be generated on the second switching contact 21.

The fail-safe switching module 1 also comprises a third switching contact 13 and a fourth switching contact 24, which are arranged in series with respect to a read-back input 6 of an evaluation device 7. The evaluation device 7 is provided with a read-back function which allows it to detect whether the first switching contact 11 or the second switching contact 21 is welded, because if welding of the switching contacts should have occurred, then the respectively associated opening contact can no longer open since, using the example of the first switching device 10, the first switching contact 11 has an operative mechanical connection to the third switching contact 13. The same principle applies to the second switching device 20 and its switching contacts.

Should the fault of “welding of the contacts” have occurred, the switching device 10,20 can be prevented from switching on again either by a higher-order control system (F-CPU) or by a corresponding monitoring system in the switching module 1. Here, the higher-order control system would be connected to a backplane bus 8, where the backplane bus 8 is in the process connected to the evaluation device 7 and can forward the fault signal to the higher-order automation system. For fault signaling in situ, i.e., directly on the switching module, a light-emitting diode LED is connected by an inverting circuit to the series connection comprising the third switching contact 13 and the fourth switching contact 24.

During switching of the load circuit 51, where the load circuit 51 comprises the load 50, a voltage source 52 and a fuse 53, a fusible cutout comprising a fuse 53 can be omitted with the aid of switching module 1 and an automatic circuit-breaker can be used instead of the fusible cut-out.

The switching module also has a redundant output and is capable of switching a second load circuit 51′ with a second load 50′, a second voltage source 52′ and a second fuse 53′.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A fail-safe switching module comprising:
a first switching device;
a second switching device, the first and second switching devices being configured to switch a load by a switching-on device;
a first temperature sensor arranged on the first switching device;
a second temperature sensor arranged on the second switching device;
a first switching-off device;
a second switching-off device, the first switching device being arranged in series with the first switching-off device and the second switching-off device;
a third switching-off device; and
a fourth switching-off device, the second switching device being arranged in series with the third switching-off device and the fourth switching-off device;
wherein the first switching-off device and the third switching-off device are configured to react to the first temperature sensor and the second switching-off device and the fourth switching-off device are configured to react to the second temperature sensor, the first, second, third and fourth switching-off devices being arranged to switch off the first and second switching devices in an event of an overtemperature of the first switching device or the second switching device.

2. The fail-safe switching module as claimed in claim 1, further comprising: a device for reducing a power loss of the first and second switching devices, the device being configured to generate a holding current for the first and second switching devices to hold a closed position with reduced power after a closed position of the switching-on device has been attained.

3. The fail-safe switching module as claimed in claim 2, wherein the device for reducing the power loss comprises:
a first reducing device arranged in series with the first switching device, and
a second reducing device which is arranged in series with the second switching device.

4. The fail-safe switching module as claimed in claim 1, wherein the switching-on device comprises a first switching contact which forms part of the first switching device, and a second switching contact which forms part of the second switching device;
wherein the first switching contact and the second switching contact are arranged in series between a first connection terminal and a second connection terminal to close a load circuit by activating the first and second switching devices; and wherein the switching devices are arranged between a first activating wire and a second activating wire.

5. The fail-safe switching module as claimed in claim 4, wherein, in addition to the series connection of switching-off devices of the first switching device, a first enabling device is arranged between the first and second activating wires; and wherein the first enabling device is configured to delay activation of the first switching device.

6. The fail-safe switching module as claimed in claim 5, wherein the first enabling device is connected to a first delay circuit.

7. The fail-safe switching module as claimed in claim 5, wherein the second switching device is arranged in series with a second enabling device between the first and second activating wires; and wherein the second enabling device is configured to extend activation of the second switching device.

8. The fail-safe switching module as claimed in claim 6, wherein the second switching device is arranged in series with a second enabling device between the first and second activating wires; and wherein the second enabling device is configured to extend activation of the second switching device.

9. The fail-safe switching module as claimed in claim 6, wherein the second enabling device is connected to a second delay circuit.

10. The fail-safe switching module as claimed in claim 7, wherein the second enabling device is connected to a second delay circuit.

11. The fail-safe switching module as claimed in claim 5, further comprising:
an energy store in particular a buffer capacitor arranged between the activating wires to extend activation of the second switching device.

12. The fail-safe switching module as claimed in claim 4, wherein the first switching device comprises a third switching contact and the second switching device comprises a fourth switching contact; and wherein the first and the second switching contacts comprise make contacts and the third and the fourth switching contacts comprise break contacts.

13. The fail-safe switching module as claimed in claim 12, further comprising:
an evaluation device having a read-back input;
wherein the third switching contact and the fourth switching contact are arranged in series with respect to the read-back input of the evaluation device; and wherein the read-back input comprises an inverting input.

14. The fail-safe switching module as claimed in one of claim 4, further comprising:
a backplane bus configured for modular construction of a decentralized automation system comprising a plurality of electronic modules located next to each other.

15. The fail-safe switching module as claimed in claim 1, further comprising: a housing into which the first and second switching devices are compactly introduced to eliminate air cooling of the first and second switching devices.

16. The fail-safe switching module as claimed in one of claim 11, wherein the energy store comprises a buffer capacitor.
